(19) United States
(12) Patent Application Publication
(10) Pub. No.: US 2018/0317207 A1
(43) Pub. Date: Nov. 1, 2018

(54) METHOD OF EFFICIENT DOWNLINK CONTROL INFORMATION TRANSMISSION

(71) Applicant: Mediatek Inc., Hsin-Chu (TW)

(72) Inventors: Yiju Liao, Hsinchu (TW); Chien Hwa Hwang, Hsinchu (TW); Chien-Chang Li, Hsinchu (TW); Pei-Kai Liao, Hsinchu (TW)

(21) Appl. No.: 15/963,366

(22) Filed: Apr. 26, 2018

Related U.S. Application Data
(60) Provisional application No. 62/490,644, filed on Apr. 27, 2017.

(51) Int. Cl. H04W 72/04; H04L 5/00

(52) U.S. Cl. CPC H04W 72/042; H04W 72/0446; H04L 5/001

(57) ABSTRACT

An UE receives a downlink control channel. The UE also receives an aggregation indication indicating that a downlink control channel contains downlink control information (DCI) for one or more resource locations of the UE. The UE further determines that a payload size selected from a list of payload sizes is a size of a payload of the downlink control channel. The UE further determines an entry size of each entry of a number of DCI entries that are included in the payload and are corresponding to the one or more resource locations based on downlink transmission parameters at the one or more resource locations. The UE also locates from the payload, based on the selected payload size and the entry sizes of the number of DCI entries, bits of each entry of the number of DCI entries.

### CROSS-REFERENCE TO RELATED APPLICATION(S)

This application claims the benefit of U.S. Provisional Application Ser. No. 62/490,644, filed Apr. 27, 2017, entitled “METHOD OF EFFICIENT DOWNLINK CONTROL INFORMATION TRANSMISSION,” which is expressly incorporated by reference herein in its entirety.

### BACKGROUND

### Field

The present disclosure relates generally to communication systems, and more particularly, to user equipment (UE) that processes transmitted aggregated downlink control information.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE of a wireless communication system. The UE receives the downlink control channel. The UE also receives an aggregation indication indicating that a downlink control channel contains downlink control information (DCI) for one or more resource locations of the UE. The one or more resource locations are (a) one or more component carriers scheduled for downlink communication, or (b) one or more time slots on a particular component carrier. The UE further determines that a payload size selected from a list of payload sizes is a size of a payload of the downlink control channel. The UE further determines an entry size of each entry of a number of DCI entries that are included in the payload and are corresponding to the one or more resource locations based on downlink transmission parameters at the one or more resource locations. The UE also locates from the payload, based on the selected payload size and the entry sizes of the number of DCI entries, bits of each entry of the number of DCI entries.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a DL frame structure, DL channels within the DL frame structure, an UL frame structure, and UL channels within the UL frame structure, respectively.

FIG. 3 is a diagram illustrating a base station in communication with a UE in an access network.

FIG. 4 illustrates an example logical architecture of a distributed access network.

FIG. 5 illustrates an example physical architecture of a distributed access network.

FIG. 6 is a diagram showing an example of a DL-centric subframe.

FIG. 7 is a diagram showing an example of an UL-centric subframe.

FIG. 8 is a diagram showing communications between a base station and a UE using cross-carrier scheduling.

FIG. 9 is a diagram showing communications between a base station and a UE using cross-slot scheduling.

FIG. 10 is a diagram of an example format of an aggregated downlink control channel in accordance with a first technique using cross-carrier scheduling.

FIG. 11 is a diagram of an example format of an aggregated DCI message in accordance with the first technique using cross-slot scheduling.

FIG. 12 is a diagram of an example format of an aggregated downlink control channel in accordance with a second technique using cross-carrier scheduling.

FIG. 13 is a diagram of an example format of an aggregated downlink control channel in accordance with the second technique using cross-slot scheduling.

FIG. 14 is a flowchart of a first method (process) for processing a downlink control channel by a UE.

FIG. 15 is a flowchart of a second method (process) for processing a downlink control channel by a UE.

FIG. 16 is a conceptual data flow diagram illustrating the data flow between different components/means in an exemplary apparatus.

FIG. 17 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

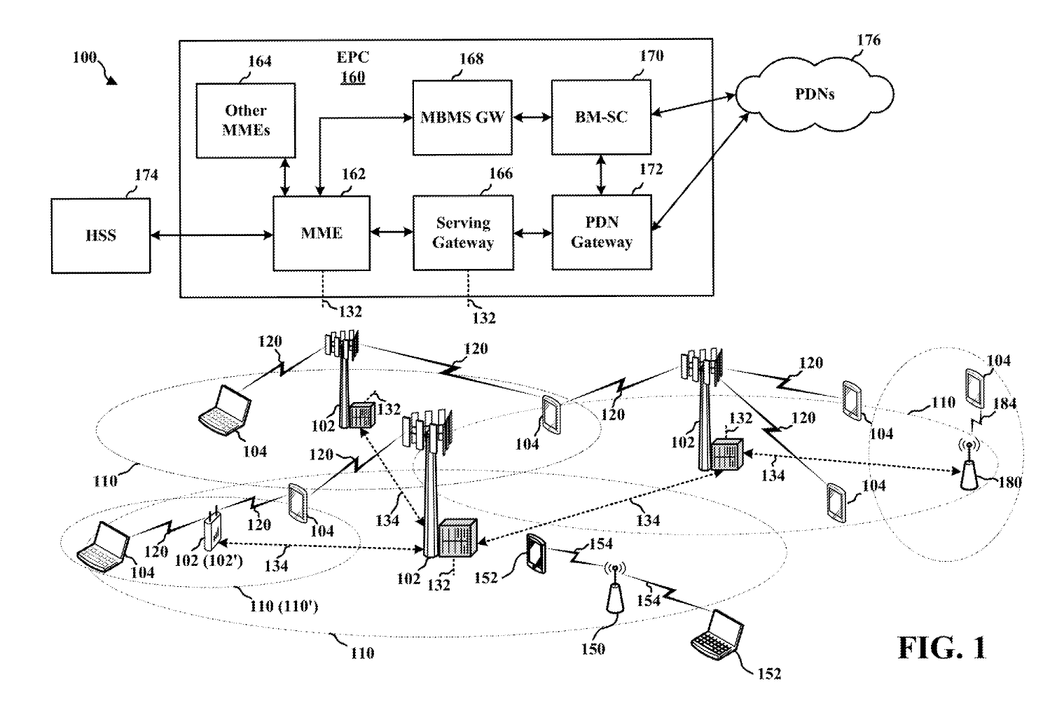

FIG. 1 is a diagram illustrating an example of a wireless communications system and an access network 100. The wireless communications system (also referred to as a wireless wide area network (WWAN)) includes base stations 102, UEs 104, and an Evolved Packet Core (EPC) 160. The base stations 102 may include macro cells (high power cellular base station) and/or small cells (low power cellular base station). The macro cells include base stations. The small cells include femtocells, picocells, and microcells.

The base stations 102 (collectively referred to as Evolved Universal Mobile Telecommunications System (UMTS) Terrestrial Radio Access Network (E-UTRAN)) interface with the EPC 160 through backhaul links 132 (e.g., S1 interface). In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100 MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

The gNodeB (gNB) 180 may operate in millimeter wave (mmW) frequencies and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 184 with the UE 104 to compensate for the extremely high path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is coupled to the PDN Gateway 172. The PDN Gateway 172 provides UE IP address allocation as well as other functions. The PDN Gateway 172 and the BM-SC 170 are coupled to the IP Services 176. The IP Services 176 may include the Internet, an intranet, an IP Multimedia Subsystem (IMS), a PS Streaming Service (PSS), and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The base station may also be referred to as a gNB, Node B, evolved Node B (eNB), an access point, a base transceiver station, a radio base station, a radio transceiver, a transceiver function, a basic service set (BSS), an extended service set (ESS), or some other suitable terminology. The base station 102 provides an access point to the EPC 160 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a toaster, or any other similar functioning device. Some of the UEs 104 may be referred to as IoT devices (e.g., parking meter, gas pump, toaster, vehicles, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

In certain aspects, the UE 104 determines, via a CSI component 192, a plurality of messages containing channel state information to be reported to a base station. The UE 104 also determines, via a reporting module 194, a priority level for each of the plurality of messages based on at least one predetermined rule. The UE 104 further selects one or more messages from the plurality of messages based on priority levels of the plurality of messages. The UE 104 then sends the selected one or more messages to the base station.

In certain aspects, the UE 104 determines, via the CSI component 192, a first message and a second message containing channel state information to be reported to a base station. The UE 104 also determines, via the reporting module 194, that a priority level of the first message is higher than a priority level of the second message based on at least one predetermined rule. The UE 104 further maps sets of information bits of the first message to a first plurality of input bits of an encoder and sets of information bits of the second message to a second plurality of input bits of the encoder. The first plurality of input bits offer an error protection level higher than an error protection level offered by the second plurality of input bits.

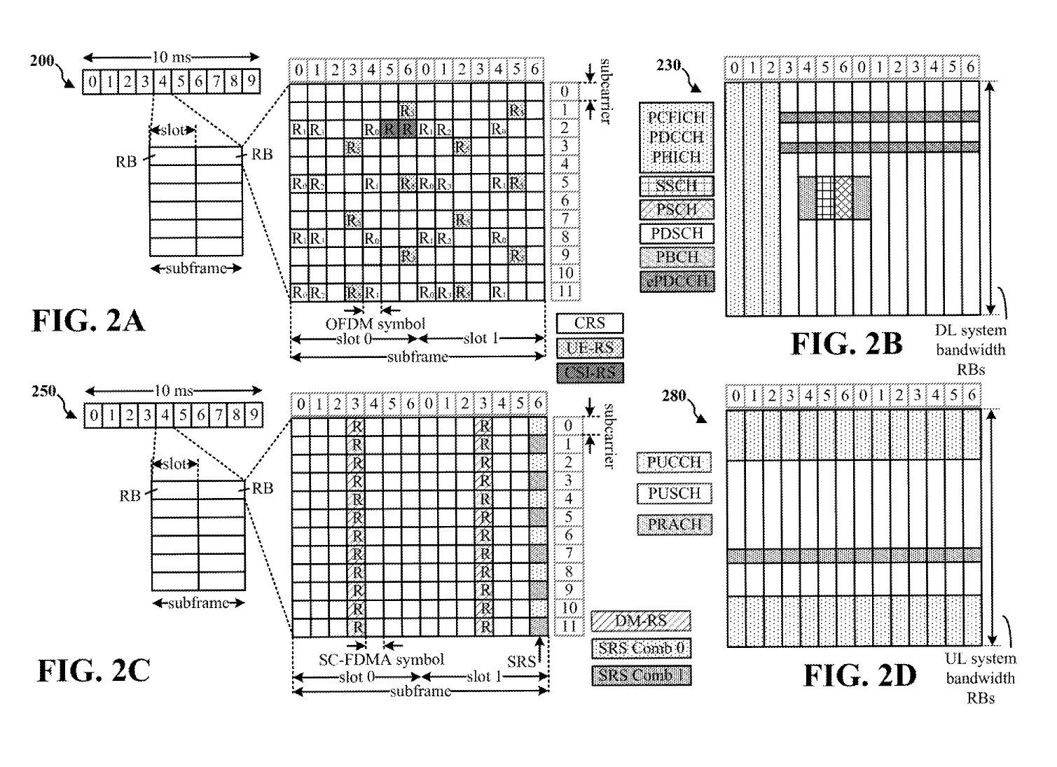

FIG. 2A is a diagram 200 illustrating an example of a DL frame structure. FIG. 2B is a diagram 230 illustrating an example of channels within the DL frame structure. FIG. 2C is a diagram 250 illustrating an example of an UL frame structure. FIG. 2D is a diagram 280 illustrating an example of channels within the UL frame structure. Other wireless communication technologies may have a different frame structure and/or different channels. A frame (10 ms) may be divided into 10 equally sized subframes. Each subframe may include two consecutive time slots. A resource grid may be used to represent the two time slots, each time slot including one or more time concurrent resource blocks (RBs) (also referred to as physical RBs (PRBs)). The resource grid is divided into multiple resource elements (REs). For a normal cyclic prefix, an RB contains 12 consecutive subcarriers in the frequency domain and 7 consecutive symbols (for DL, OFDM symbols; for UL, SC-FDMA symbols) in the time domain, for a total of 84 REs. For an extended cyclic prefix, an RB contains 12 consecutive subcarriers in the frequency domain and 6 consecutive symbols in the time domain, for a total of 72 REs. The number of bits carried by each RE depends on the modulation scheme.

As illustrated in FIG. 2A, some of the REs carry DL reference (pilot) signals (DL-RS) for channel estimation at the UE. The DL-RS may include cell-specific reference signals (CRS) (also sometimes called common RS), UE-specific reference signals (UE-RS), and channel state information reference signals (CSI-RS). FIG. 2A illustrates CRS for antenna ports 0, 1, 2, and 3 (indicated as R0, R1, R2, and R3, respectively), UE-RS for antenna port 5 (indicated as R5), and CSI-RS for antenna port 15 (indicated as R). FIG. 2B illustrates an example of various channels within a DL subframe of a frame. The physical control format indicator channel (PCFICH) is within symbol 0 of slot 0, and carries a control format indicator (CFI) that indicates whether the physical downlink control channel (PDCCH) occupies 1, 2, or 3 symbols (FIG. 2B illustrates a PDCCH that occupies 3 symbols). The PDCCH carries downlink control information (DCI) within one or more control channel elements (CCEs), each CCE including nine RE groups (REGs), each REG including four consecutive REs in an OFDM symbol. A UE may be configured with a UE-specific enhanced PDCCH (ePDCCH) that also carries DCI. The ePDCCH may have 2, 4, or 8 RB pairs (FIG. 2B shows two RB pairs, each subset including one RB pair). The physical hybrid automatic repeat request (ARQ) (HARQ) indicator channel (PHICH) is also within symbol 0 of slot 0 and carries the HARQ indicator (HI) that indicates HARQ acknowledgement (ACK)/negative ACK (NACK) feedback based on the physical uplink shared channel (PUSCH). The primary synchronization channel (PSCH) may be within symbol 6 of slot 0 within subframes 0 and 5 of a frame. The PSCH carries a primary synchronization signal (PSS) that is used by a UE to determine subframe/symbol timing and a physical layer identity. The secondary synchronization channel (SSCH) may be within symbol 5 of slot 0 within subframes 0 and 5 of a frame. The SSCH carries a secondary synchronization signal (SSS) that is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DL-RS. The physical broadcast channel (PBCH), which carries a master information block (MIB), may be logically grouped with the PSCH and SSCH to form a synchronization signal (SS) block. The MIB provides a number of RBs in the DL system bandwidth, a PHICH configuration, and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry demodulation reference signals (DM-RS) for channel estimation at the base station. The UE may additionally transmit sounding reference signals (SRS) in the last symbol of a subframe. The SRS may have a comb structure, and a UE may transmit SRS on one of the combs. The SRS may be used by a base station for channel quality estimation to enable frequency-dependent scheduling on the UL. FIG. 2D illustrates an example of various channels within an UL subframe of a frame. A physical random access channel (PRACH) may be within one or more subframes within a frame based on the PRACH configuration. The PRACH may include six consecutive RB pairs within a subframe. The PRACH allows the UE to perform initial system access and achieve UL synchronization. A physical uplink control channel (PUCCH) may be located on edges of the UL system bandwidth. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

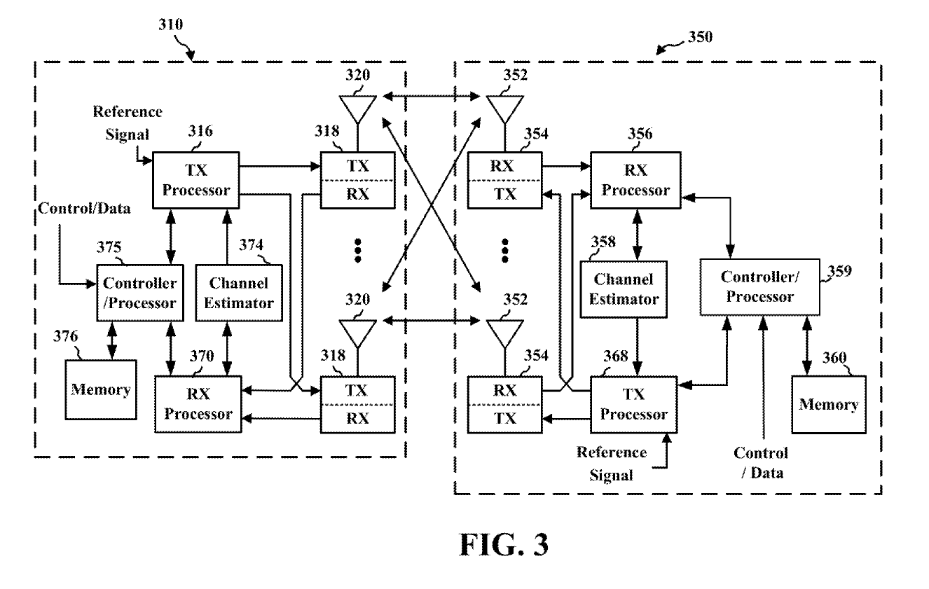

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission. The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

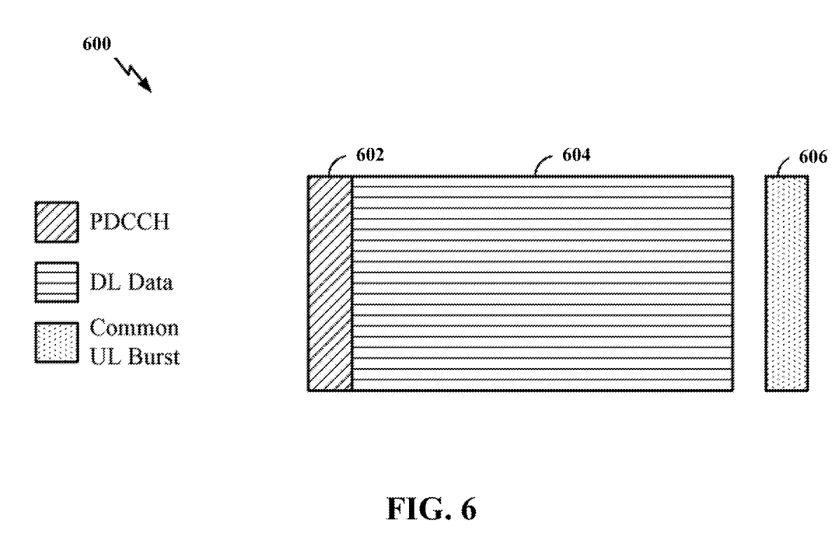

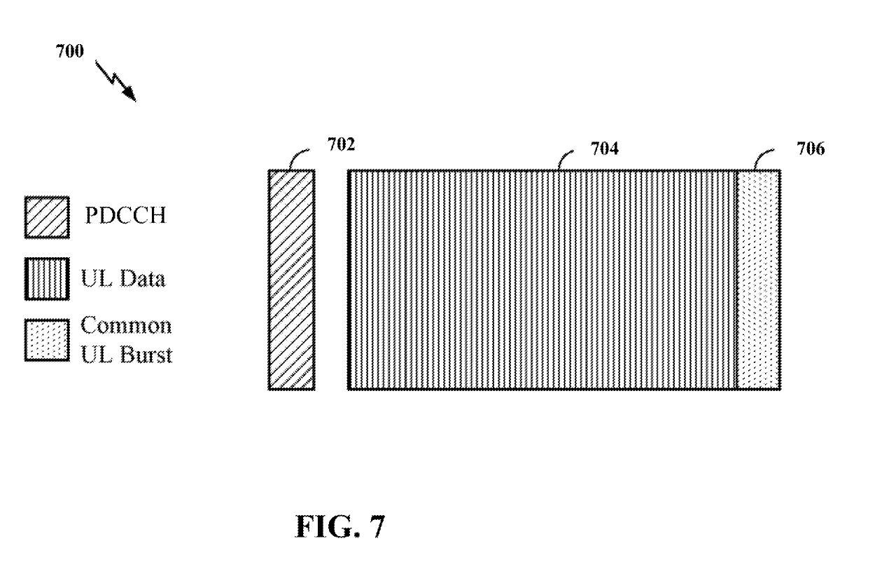

A single component carrier bandwidth of 100 MHZ may be supported. In one example, NR resource blocks (RBs) may span 12 sub-carriers with a sub-carrier bandwidth of 75 kHz over a 0.1 ms duration or a bandwidth of 15 kHz over a 1 ms duration. Each radio frame may consist of 10 or 50 subframes with a length of 10 ms. Each subframe may have a length of 1 ms or 0.2 ms. Each subframe may indicate a link direction (i.e., DL or UL) for data transmission and the link direction for each subframe may be dynamically switched. Each subframe may include DL/UL data as well as DL/UL control data. UL and DL subframes for NR may be as described in more detail below with respect to FIGS. 6 and 7.

Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells. Alternatively, NR may support a different air interface, other than an OFDM-based interface.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS); in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

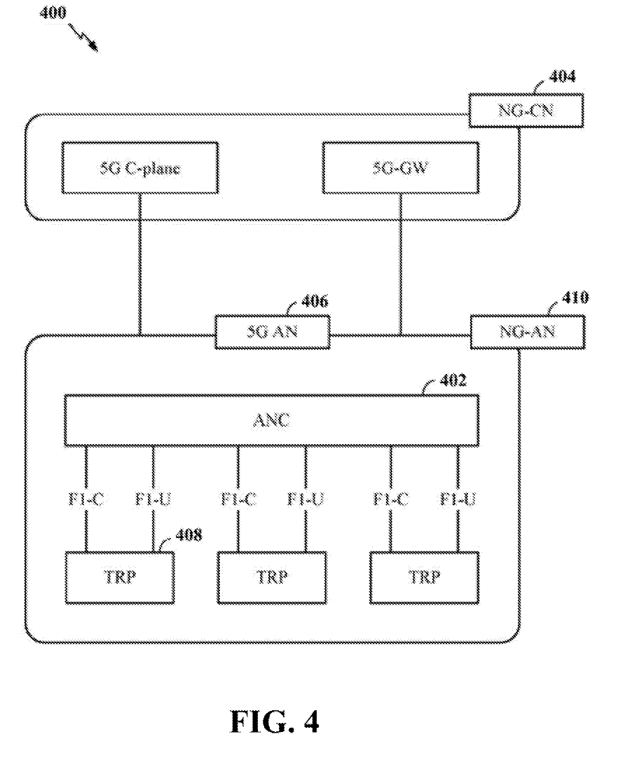

FIG. 4 illustrates an example logical architecture 400 of a distributed RAN, according to aspects of the present disclosure. A 5G access node 406 may include an access node controller (ANC) 402. The ANC may be a central unit (CU) of the distributed RAN 400. The backhaul interface to the next generation core network (NG-CN) 404 may terminate at the ANC. The backhaul interface to neighboring next generation access nodes (NG-ANs) may terminate at the ANC. The ANC may include one or more TRPs 408 (which may also be referred to as BSs, NR BSs, Node Bs, 5G NBs, APs, or some other term). As described above, a TRP may be used interchangeably with “cell.”

The respective TRPs 408 may be a distributed unit (DU). The TRPs may be coupled to one ANC (ANC 402) or more than one ANC (not illustrated). For example, for RAN sharing, radio as a service (RaaS), and service specific AND deployments, the TRP may be coupled to more than one ANC. A TRP may include one or more antenna ports. The TRPs may be configured to individually (e.g., dynamic selection) or jointly (e.g., joint transmission) serve traffic to a UE.

The local architecture of the distributed RAN 400 may be used to illustrate fronthaul definition. The architecture may be defined to support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 410 may support dual connectivity with NR. The NG-AN may share a common fronthaul for LTE and NR.

The architecture may enable cooperation between and among TRPs 408. For example, cooperation may be preset within a TRP and/or across TRPs via the ANC 402. According to aspects, no inter-TRP interface may be needed/present.

According to aspects, a dynamic configuration of split logical functions may be present within the architecture of the distributed RAN 400. The PDCP, RLC, MAC protocol may be adaptably placed at the ANC or TRP.

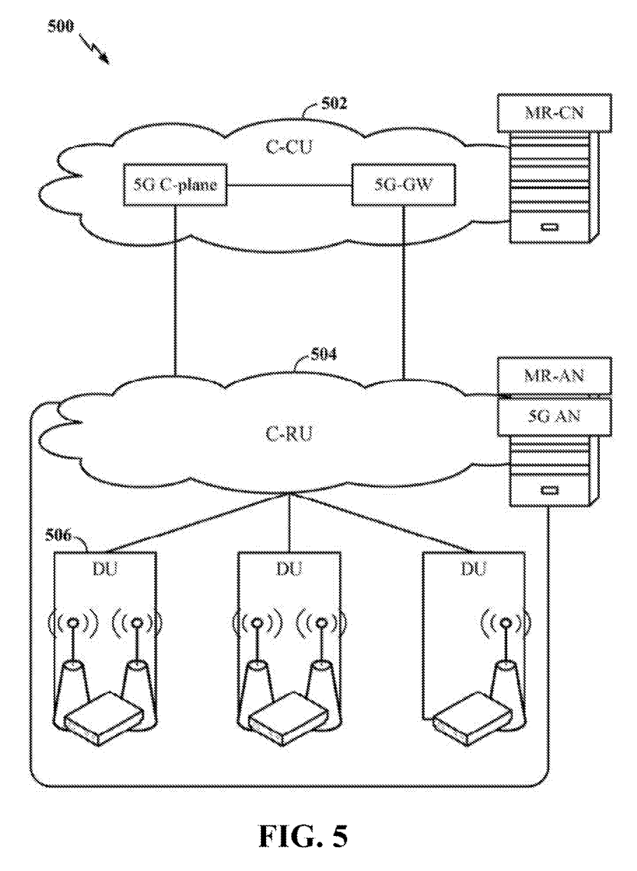

FIG. 5 illustrates an example physical architecture of a distributed RAN 500, according to aspects of the present disclosure. A centralized core network unit (C-CU) 502 may host core network functions. The C-CU may be centrally deployed. C-CU functionality may be offloaded (e.g., to advanced wireless services (AWS)), in an effort to handle peak capacity. A centralized RAN unit (C-RU) 504 may host one or more ANC functions. Optionally, the C-RU may host core network functions locally. The C-RU may have distributed deployment. The C-RU may be closer to the network edge. A distributed unit (DU) 506 may host one or more TRPs. The DU may be located at edges of the network with radio frequency (RF) functionality.

FIG. 6 is a diagram 600 showing an example of a DL-centric subframe. The DL-centric subframe may include a control portion 602. The control portion 602 may exist in the initial or beginning portion of the DL-centric subframe. The control portion 602 may include various scheduling information and/or control information corresponding to various portions of the DL-centric subframe. In some configurations, the control portion 602 may be a physical DL control channel (PDCCH), as indicated in FIG. 6. The DL-centric subframe may also include a DL data portion 604. The DL data portion 604 may sometimes be referred to as the payload of the DL-centric subframe. The DL data portion 604 may include the communication resources utilized to communicate DL data from the scheduling entity (e.g., UE or BS) to the subordinate entity (e.g., UE). In some configurations, the DL data portion 604 may be a physical DL shared channel (PDSCH).

The DL-centric subframe may also include a common UL portion 606. The common UL portion 606 may sometimes be referred to as an UL burst, a common UL burst, and/or various other suitable terms. The common UL portion 606 may include feedback information corresponding to various other portions of the DL-centric subframe. For example, the common UL portion 606 may include feedback information corresponding to the control portion 602. Non-limiting examples of feedback information may include an ACK signal, a NACK signal, a HARQ indicator, and/or various other suitable types of information. The common UL portion 606 may include additional or alternative information, such as information pertaining to random access channel (RACH) procedures, scheduling requests (SRs), and various other suitable types of information.

As illustrated in FIG. 6, the end of the DL data portion 604 may be separated in time from the beginning of the common UL portion 606. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric subframe and alternative structures having similar features may exist without necessarily deviating from the aspects described herein.

FIG. 7 is a diagram 700 showing an example of an UL-centric subframe. The UL-centric subframe may include a control portion 702. The control portion 702 may exist in the initial or beginning portion of the UL-centric subframe. The control portion 702 in FIG. 7 may be similar to the control portion 602 described above with reference to FIG. 6. The UL-centric subframe may also include an UL data portion 704. The UL data portion 704 may sometimes be referred to as the pay load of the UL-centric subframe. The UL portion may refer to the communication resources utilized to communicate UL data from the subordinate entity (e.g., UE) to the scheduling entity (e.g., UE or BS). In some configurations, the control portion 702 may be a physical DL control channel (PDCCH).

As illustrated in FIG. 7, the end of the control portion 702 may be separated in time from the beginning of the UL data portion 704. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric subframe may also include a common UL portion 706. The common UL portion 706 in FIG. 7 may be similar to the common UL portion 706 described above with reference to FIG. 7. The common UL portion 706 may additionally or alternatively include information pertaining to channel quality indicator (CQI), sounding reference signals (SRSs), and various other suitable types of information. One of ordinary skill in the art will understand that the foregoing is merely one example of an UL-centric subframe and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

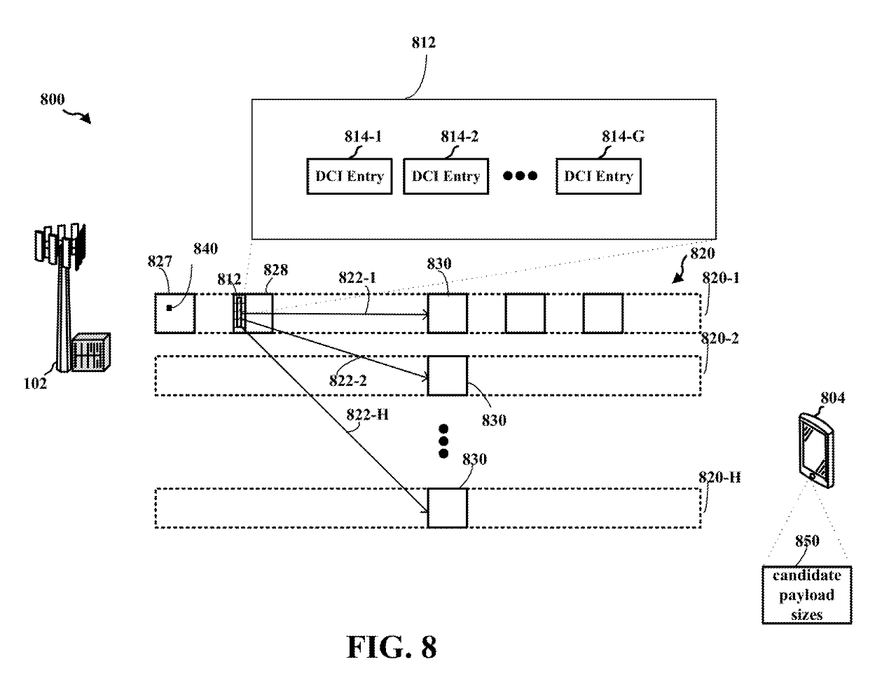

FIG. 8 is a diagram illustrating communication network 800 between a base station 102 and a UE 804 that is in a cell of the base station 102. The base station 102 and the UE 804 may establish multiple component carriers 820-1, 820-2, . . . , 820-H. In this example, the component carrier 820-1 is a primary component carrier, while the other component carriers are secondary component carriers. In certain configurations, as described below, the base station 102 may send aggregated DCI to the UE 804. In particular, the base station 102 may initially send a DCI aggregation indication 840 (e.g., via signaling) in a slot 827. The DCI aggregation indication 840 indicates that subsequent PDCCHs include an aggregation of (e.g., a combination of more than one) DCI entries 814. Subsequently, the base station 102 may transmit a PDCCH 812 directed to the UE 804 on the primary component carrier 820-1 in a slot 828. The PDCCH 812 may include DCI for one or more of the multiple component carriers 820-1, 820-2, . . . , 820-H in the slot 830 or DCI for one component carrier 820-x, where x is 1, 2, . . . , H, in one or more slots. In one example, the start timing of the slot 828 is the same as that of the slot 830. In another example, the start timing of the slot 828 may be earlier than that of the starting timing of slot 830. Further, in this example, the slots 830 on different component carriers 820-1, 820-2, . . . , 820-H are aligned. In other words, the start of each slot 830 is at the same time point and the end of each slot 830 is at another, same time point. In another example, where the component carriers have different subcarrier spacing, the slots 830 on different component carriers 820-1, 820-2, . . . , 820-H may not be aligned.

A payload of the PDCCH 812 can include aggregated DCI entries 814-1, 814-2, . . . 814-G (referred to collectively as DCI entries 814), wherein G is the number of DCI entries that are aggregated. Each DCI entry 814 is mapped to a resource location of the UE 804. A resource location can be defined by a component carrier and a slot. When a particular DCI entry 814 is mapped to a resource location, the DCI information included in that DCI entry provides control information for that resource location.

The DCI aggregation indication 840 can be provided to the UE 804, for example, as an RRC parameter. The DCI aggregation indication 840 can further indicate whether the aggregated DCI entries 814 are mapped to component carriers 820 or slots 830. The base station 102 can form the DCI entries 814-1, 814-2, . . . 814-G of bits, aggregate the DCI entries 814-1, 814-2, . . . 814-G into the PDCCH 812.

In accordance with certain techniques, the base station 102 can provide, a set of candidate payload sizes 850 to the UE 804, or the UE 804 can otherwise be provided with the candidate payload sizes 850, such as by higher level signaling, e.g., by configuration signals sent by higher layer signaling (e.g., RRC or MAC control element (CE)) to configure the UE 804. The UE 804 stores the candidate payload sizes 850 in a storage device of the UE 804.

Additionally, the UE 804 can be configured by the base station 102 or other higher layer signaling with configuration information that informs the UE 804 which possible secondary component carriers 820 or slots 830 are mapped to by the DCI entries 814 of the primary component carrier 820-1; whether the component carriers 820 (e.g., primary component carrier 820-1 and secondary component carriers 820-2-820H, if any) use FDD or TDD; channel bandwidths of the component carriers 820; and transmission modes (TMs) configured for each of the component carriers 820.

The UE 804 receives downlink communications via the primary component carrier 820-1 only or via the primary component carrier 820-1 and/or one or more secondary component carriers 820-2 . . . 820-H, where H is the total number of the component carriers. When the UE 804 utilizes cross-carrier scheduling, the UE 804 may receive DCI information for one secondary component carrier via the primary component carrier 820-1 or via another secondary component carrier.

In certain configurations as shown in FIG. 8, the aggregation indication 840 indicates that there are aggregated DCI entries 814 that map to multiple component carriers 820 for cross-carrier scheduling. The DCI entries 814 are mapped to the primary component carrier 820-1 and one or more of the secondary component carriers 820-2-820-H. Arrow 822-1 represents mapping of one of the DCI entries 814 to the primary component carrier 820-1. Arrow 822-2 represents mapping of a different one of the DCI entries 814 to secondary component carrier 820-2. Arrow 822-G represents mapping of still a different one of the DCI entries 814 to secondary component carrier 820-H. It is understood that the number of DCI entries (e.g., G) and secondary component carriers (e.g., H) can each vary, and can be different relative to one another.

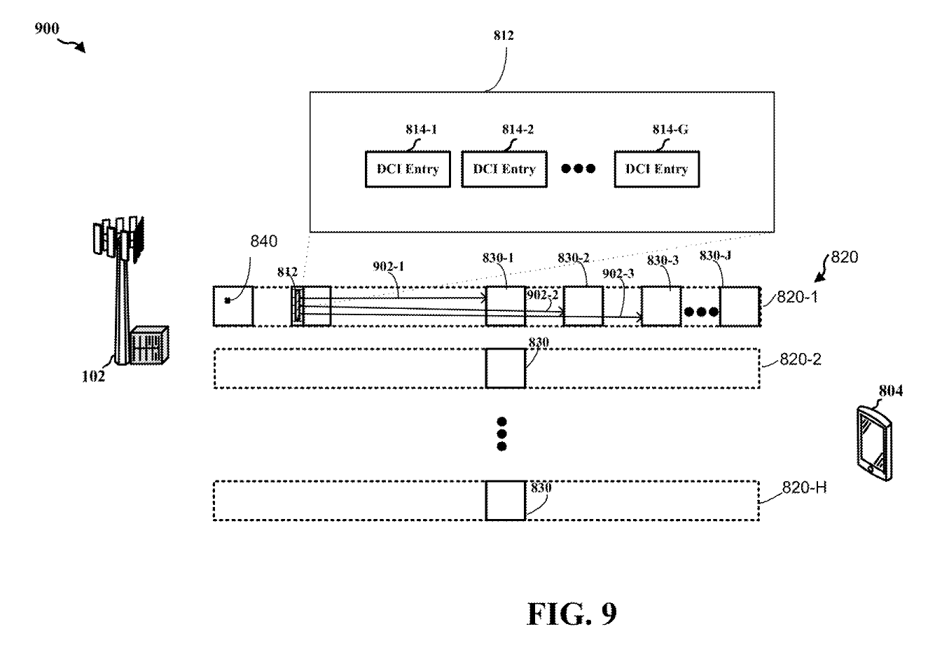

With reference to FIG. 9, a diagram of the communication network 800 is shown illustrating certain configurations in which the aggregation indication 840 indicates that there are aggregated DCI entries 814 that map to multiple slots 830 for cross-slot scheduling. When using cross-slot scheduling, PDSCH is scheduled in the multiple slots 830. The DCI entries 814 can be mapped to slots 830-1, 830-2, . . . 830-J, where J is a number of slots in the downlink communication. Arrow 902-1 represents mapping of one of the DCI entries 814 to slot 830-1, arrow 902-2 represents mapping of a different one of the DCI entries 814 to slot 830-2, and arrow 902-3 represents mapping of still a different one of the DCI entries 814 to slot 830-3. It is understood that the number of slots (e.g., J) can vary, and the number of slots (e.g., J) can be different relative to the number of DCI entries 814 (e.g., G).

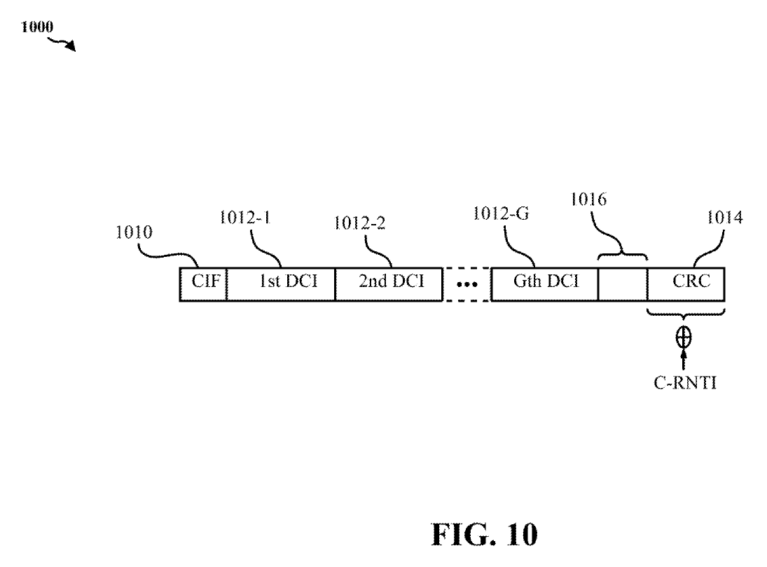

FIG. 10 is a diagram illustrating a payload 1000 of an example downlink control channel, such as PDCCH 812 from a base station 102 provided to the UE 804, as shown in FIG. 8, in accordance with a first technique. In this example, the UE 804 is configured for cross-carrier scheduling using DCI entry aggregation. The PDCCH 812 is sent via the primary component carrier 820-1.

In this technique, the payload 1000 generated by the base station 102 includes sets of information bits 1012-1, 1012-2, . . . 1012-G that form the respective DCI entries 814-1, 814-2, . . . 814-G. The number of bits in each of sets of information bits 1012-1, 1012-2, . . . 1012-G determines the size of the entry of each of the respective DCI entries 814-1, 814-2, . . . 814-G, wherein the entry sizes of the respective DCI entries 814-1, 814-2, . . . 814-G can have different lengths. The base station 102 concatenates (or aggregates) the sets of information bits 1012-1, 1012-2, . . . 1012-G together to generate combined bits.

In this example, the base station 102 may further generate a carrier indicator field (CIF) 1010 and include it in payload 1000. The CIF 1010 indicates the component carriers 820 to which the respective DCI entries 814-1, 814-2, . . . 814-G are mapped. The CIF 1010 may include a pre-configured number of bits (e.g., 1 bit, 2 bits, 3 bits, etc.). In an example, the CIF 1010 can be configured as a bit-map, each bit corresponding to a component carrier 820. Each bit of the CIF 1010 that is set to “1” indicates that the component carrier 820 that corresponds to that bit is used for downlink communication and one of the DCI entries 814-1, 814-2, . . . 814-G is mapped to that component carrier 820. Each bit of the CIF 1010 that is set to “0” indicates that the component carrier 820 that corresponds to that bit is not being used for downlink communication. Regarding slot aggregation, UL grant and DL assignment intended to the same UE can be transmitted in the same slot.

In an example, a CIF 1010 has four bits, which indicates that the DCI entries 814-1, 814-2, . . . 814-G can be mapped to four active component carriers 820 that are allocated for the UE 804 to use. In this example, the CIF 1010 is provided as having the value “1001,” which indicates the DCI entries 814-1, 814-2, . . . 814-G correspond to the first component carrier 820-1 and a fourth component carrier 820-4 (not shown) of the four allocated active component carriers. The size of the CIF 1010 can be fixed, e.g., the maximum number of allowed active component carriers with cross-carrier scheduling, or dynamic, e.g., the number of active component carriers with cross-carrier scheduling.

Further, the base station 102 generates aggregate protection bits 1014 (such as CRC, as indicated in the example shown in FIG. 10, without limitation to a particular error-detection code) that protect the CIF 1010 and the concatenated sets of information bits 1012-1, 1012-2, . . . 1012-G. The base station 102 obtains a Radio Network Temporary Identifier (RNTI) of the UE 804 and uses the RNTI obtained to scramble the CRC to generate the aggregate protection bits 1014. In an example, the base station 102 can apply an exclusive-OR operation to the CRC and the RNTI to generate the aggregate protection bits 1014. The base station 102 appends the aggregate protection bits 1014 to the CIF 1010 and the concatenated sets of information bits 1012-1, 1012-2, . . . 1012-G, all of which are included in payload 1000. The base station can further add padding bits 1016 to occupy unused bits of the PDCCH 812 and include the padding bits 1016 in payload 1000. Since the number of sets of information bits 1012-1, 1012-2, . . . 1012-G of the respective DCI entries 814-1, 814-2, . . . 814-G that are to occupy the PDCCH 812 is initially unknown to the UE 804, the UE 804 does not know the size of the padding bits 1016. As such, the number of bits included in the padding bits 1016 may be unknown until the sets of information bits 1012-1, 1012-2, . . . 1012-G are determined.

Subsequently, in this example, the base station 102 inputs at least a portion of the combined bits (e.g., sets of information bits 1012-1, 1012-2, . . . 1012-G) to an encoder, e.g., a Polar code encoder, to generate encoded bits containing the DCI entries 814-1, 814-2, . . . 814-G. The base station 102 then maps the encoded bits to symbols carried in one or more CCEs of the primary component carrier 820-1 and transmits those symbols to the UE 804 via the primary component carrier 820-1.

In one example for demonstrating the advantages that may be achieved by this technique, when using Polar code, a coding gain is proportional to the length of the information block, such as information blocks included in the payload of a PDCCH 812. By concatenating DCI entries into a single payload, the length of the information block is increased and channel coding gain is thus improved due to the benefit provided by Polar code. Other advantages include that protection bit overhead can be reduced and blind decoding can be reduced, as described infra.

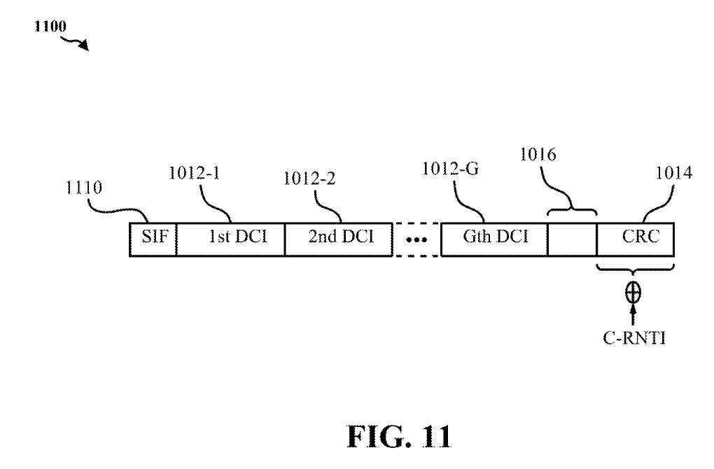

FIG. 11 is a diagram illustrating a payload 1100 of an example downlink control channel, such as PDCCH 812 from base station 102 provided to the UE 804 in accordance with the first technique, as shown in FIG. 9. In this example, the UE 804 is configured for cross-slot scheduling using DCI entry aggregation. Similar to the example shown in FIG. 10, the PDCCH 812 is sent via the primary component carrier 820-1.

Similar to the example shown in FIG. 11, the payload 1000 generated by the base station 102 includes sets of information bits 1012-1, 1012-2, . . . 1012-G that are concatenated (or aggregated) together to generate combined bits.

In this example, instead of CIF 1010 of example payload 1000, the base station 102 generates a slot indicator field (SIF) 1110 and includes SIF 1110 in the payload 1100. The SIF 1110 indicates slots 830 to which the respective DCI entries 814-1, 814-2, . . . 814-G are mapped. Similar to CIF 1010, the SIF 1110 may include a pre-configured number of bits (e.g., 1 bit, 2 bits, 3 bits, etc.) that can be configured as a bit-map, each bit corresponding to a different slot 830. Each bit of the SIF 1110 that is set to “1” indicates that the slot 830 is used for scheduling data for downlink communication, such as PDSCH, and one of the DCI entries 814-1, 814-2, . . . 814-G is mapped to that slot 802. Each bit of the SIF 1110 that is set to “0” indicates that the slot 830 that corresponds to that bit is not being used for scheduling data for downlink communication. When the UE 804 is configured for cross-slot scheduling, UL grant and DL assignment for the UE 804 can be transmitted in the same slot 830. In an example, a SIF 1110 has four bits, which indicates that the DCI entries 814-1, 814-2, . . . 814-G can be mapped to four active slots 830 that are available for the UE 804 to use for scheduling downlink data. In the example, the SIF 1110 is provided as having the value “1010,” which indicates the DCI entries 814-1, 814-2, . . . 814-G correspond to the slots 830-1 and 830-3 of four available slots 830-1-830. An available slot can be a slot as described supra, or can be a mini slot, which is a portion of a slot. The size of the SIF 1110 can be fixed, e.g., the maximum number of allowed available slots with cross-slot scheduling or slots with slot aggregation, or dynamic, e.g., the number of available slots with cross-slot aggregation.

The payload 1100 can also include aggregate protection bits 1014 and padding bits 1016 as described with respect to FIG. 10. Similar to the description of FIG. 10, the aggregate protection bits 1014 protect the SIF 1110 and the concatenated sets of information bits 1012-1, 1012-2, . . . 1012-G.

Similar to the example shown in FIG. 10, the base station 102 can also input at least a portion of the combined bits (e.g., sets of information bits 1012-1, 1012-2, . . . 1012-G) to an encoder, e.g., a Polar code encoder, to generate encoded bits containing the DCI entries 814-1, 814-2, . . . 814-G. The base station 102 can then map the encoded bits to symbols carried in one or more CCEs of the primary component carrier 820-1 and transmit those symbols to the UE 804 via the primary component carrier 820-1.

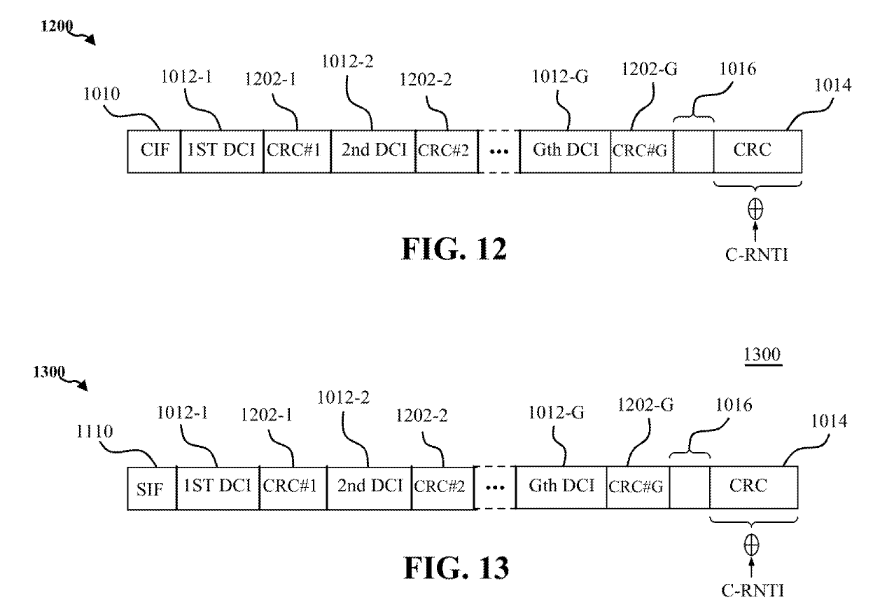

FIG. 12 is a diagram illustrating a payload 1200 of an example PDCCH 812 from a base station 102 provided to the UE 804, as shown in FIG. 8, in accordance with a second technique. In this example, the UE 804 is configured for cross-carrier scheduling using DCI entry aggregation. The PDCCH 812 is sent via the primary component carrier 820-1.

In this second technique, the payload 1200 generated by the base station 102 includes sets of information bits 1012-1, 1012-2, . . . 1012-G that form the respective DCI entries 814-1, 814-2, . . . 814-G. The number of bits in each of sets of information bits 1012-1, 1012-2, . . . 1012-G determines the size of the entry of each of the respective DCI entries 814-1, 814-2, . . . 814-G, wherein the entry sizes of the respective DCI entries 814-1, 814-2, . . . 814-G can have different lengths.

The base station 102 further generates individual protection bits 1202-1, 1202-2, . . . 1202-G, such as a CRC (without limitation to a particular type of protection bit), in association with each of the sets of information bits 1012-1, 1012-2, . . . 1012-G of the respective DCI entries 814-1, 814-2, . . . 814-G. In the example shown, the base station 102 generates a CRC of each set of individual sets of information bits 1012-1, 1012-2, . . . 1012-G. The base station 102 concatenates the pairs of sets of information bits and individual protection bits (1012-1, 1202-1), (1012-2, 1202-2) . . . (1012-G, 1202-G) together to generate combined bits, all of which are included in the payload 1200.

Similar to the example provided in FIG. 10, the base station 102 generates the CIF 1010 and includes it in payload 1200, wherein the CIF 1010 indicates the component carriers 820 to which the respective DCI entries 814-1, 814-2, . . . 814-G are mapped.

The payload 1100 can also include aggregate protection bits 1014 and padding bits 1016 as described with respect to FIG. 10. Similar to the description of FIG. 10, the aggregate protection bits 1014 protect the CIF 1010 and the concatenated sets of information bits 1012-1, 1012-2, . . . 1012-G and the individual protection bits (1012-1, 1202-1), (1012-2, 1202-2) . . . (1012-G, 1202-G).

Similar to the example shown in FIG. 10, the base station 102 can also input at least a portion of the combined bits (e.g., sets of information bits 1012-1, 1012-2, . . . 1012-G) to an encoder, e.g., a Polar code encoder, to generate encoded bits containing the DCI entries 814-1, 814-2, . . . 814-G. The base station 102 can then map the encoded bits to symbols carried in one or more CCEs of the primary component carrier 820-1 and transmit those symbols to the UE 804 via the primary component carrier 820-1.

FIG. 13 is a diagram illustrating a payload 1300 of an example downlink control channel, such as PDCCH 812 from the base station 102 provided to the UE 804, as shown in FIG. 9, in accordance with the second technique. In this example, the UE 804 is configured for cross-slot scheduling using DCI entry aggregation. The PDCCH 812 is sent via the primary component carrier 820-1.

In this second technique, the payload 1300 generated by the base station 102 includes sets of information bits 1012-1, 1012-2, . . . 1012-G that form the respective DCI entries 814-1, 814-2, . . . 814-G. The number of bits in each of sets of information bits 1012-1, 1012-2, . . . 1012-G determines the size of the entries of each of the respective DCI entries 814-1, 814-2, . . . 814-G, wherein the entry sizes of the respective DCI entries 814-1, 814-2, . . . 814-G can have different lengths.

The base station 102 further generates individual protection bits 1202-1, 1202-2, . . . 1202-G, such as a CRC (without limitation to a particular type of protection bit), in association with each of the sets of information bits 1012-1, 1012-2, . . . 1012-G of the respective DCI entries 814-1, 814-2, . . . 814-G. In the example shown, the base station 102 generates a CRC of each set of individual sets of information bits 1012-1, 1012-2, . . . 1012-G. The base station 102 concatenates the pairs of sets of information bits and individual protection bits (1012-1, 1202-1), (1012-2, 1202-2) . . . (1012-G, 1202-G) together to generate combined bits, all of which are included in the payload 1300.

Similar to the example provided in FIG. 11, the base station 102 generates the SIF 1110 and includes it in payload 1300, wherein the SIF 1110 indicates the slots 830 to which the respective DCI entries 814-1, 814-2, . . . 814-G are mapped.

The payload 1300 can also include aggregate protection bits 1014 and padding bits 1016 as described with respect to FIG. 10. Similar to the description of FIG. 10, the aggregate protection bits 1014 protect the CIF 1010 and the concatenated sets of information bits 1012-1, 1012-2, . . . 1012-G.

Similar to the example shown in FIG. 10, the base station 102 can also input at least a portion of the combined bits (e.g., sets of information bits 1012-1, 1012-2, . . . 1012-G) to an encoder, e.g., a Polar code encoder, to generate encoded bits containing the DCI entries 814-1, 814-2, . . . 814-G. The base station 102 can then map the encoded bits to symbols carried in one or more CCEs of the primary component carrier 820-1 and transmit those symbols to the UE 804 via the primary component carrier 820-1.

Referring back to FIGS. 8, 9, 10, and 11 and implementation of the first technique described supra, the UE 804 receives at least one downlink communication from the base station 102 that includes a DCI aggregation indication 840 and a PDCCH 812 that includes encoded bits. The UE 804 determines from the DCI aggregation indication 840 whether the PDCCH 812 includes an aggregation of DCI entries 814. If the UE 804 determines that the DCI entries 814 are aggregated, then the UE 804 further determines from the DCI aggregation indication 840 whether the aggregated DCI entries 814 are mapped to component carriers 820 for cross-carrier scheduling or slots 830 for cross-sot scheduling. When the UE 804 determines from the DCI aggregation indication 840 that the aggregated DCI entries 814 are mapped to one or more component carriers 820, the first technique is implemented to handle cross-carrier scheduling, referring to FIGS. 8 and 10. When the UE 804 determines from the DCI aggregation indication 840 that the aggregated DCI entries 814 are mapped to one or more slots 830, the first technique is implemented to handle cross-slot scheduling, referring to FIGS. 9 and 11.

The UE 804 decodes the encoded bits of the PDCCH 812 and bits included in the payload 1000 as shown in FIG. 10 or the payload 1100 shown in FIG. 11. The payload 1000 or 1100 includes bits that correspond to a CIF 1010 or bits that correspond to an SIF 1110, combined bits 1012-1, 1012-2, . . . 1012-G that correspond to DCI entries 814-1, 814-2, . . . 814-G, padding bits 1016 and aggregate protection bits 1014. The bits included in the payload 1000 or 1100 may be generated by the base station 102 in accordance with the techniques described supra.

The UE 804 determines a payload size of the PDCCH 812 from its stored list of candidate payload sizes 850. In this example, the list of candidate payload sizes 850 stored by the UE 804 includes (in bits) {45, 90, 135}. Further, the UE 804 has established one or more component carriers 820 with the base station 102. For example, the UE 804 may have established three component carriers CC#1, CC#2, and CC#3 withe the base station 102. The UE 804 knows whether the available component carriers 820 use FDD or TDD and knows respective bandwidths and TMs of the respective component carriers. In this example, CC#1-CC#3 use FDD, the channel bandwidths for CC#1-CC#3 are 10 MHz, 10 MHz, and 5 MHz, respectively, and CC#1-CC#3 use TM3, TM3, and TM8, respectively. In one example, the LTE Release 10 is implemented. Furthermore, based on the scheduling constraint applied in this example, only DCI entries having non-fallback TMs can be included in the PDCCH 812, and the DCI entries 814 have associated TMs included in the set {1, 2A, 2, 1D, 1B, 2B, 2C}. The UE 804 is further configured with knowledge of the size of the CIF 1010 or the SIF 1110. For example, the size of the CIF 1010 or the SIF 1110 may be three bits.

The UE 804 tests the payload sizes listed in the candidate payload sizes 850 to determine which of the candidate payload sizes 850 stored are viable candidates. For each payload size included in the list of candidate payload sizes 850, the UE 804 can assume the size of the payload of the received PDCCH 812 is the candidate payload size, locate bits that are potential protection bits for a payload having the candidate payload size, and attempt to descramble the located protection bits with the RNTI of the UE 804 to generate descrambled bits and calculate a CRC. If the calculated CRC matches the descrambled bits, the UE 804 can determine that the candidate payload size being tested is the verified size of the received payload of the received PDCCH 812. If the calculated CRC does not match the descrambled bits, a next candidate is tested until one candidate is determined to be the verified size. In the current example, the payload size 90 bits is determined to be the verified size. Once the aggregated protection bits 1014 are applied successfully, such as a successful match between the calculated CRC and the descrambled bits, the bits of the CIF 1010 or SIF 1110 and sets of information bits 1012-1, 1012-2, . . . 1012-G can be accessed.

The UE 804 further determines an entry size of each DCI entries 814-1, 814-2, . . . 814-G included in the payload of the PDCCH 812 based upon downlink transmission parameters of one or more resource locations that correspond to the DCI entries 814-1, 814-2, . . . 814-G, a scheduling constraint, and the determined payload size.

Based on the configured TM at each component carrier 820 and the channel bandwidth of the component carrier 820, the UE 804 can determine candidate entry sizes of various combinations of the DCI entries 814.

Referring back to FIGS. 8 and 10, in an example using the first technique in which the DCI aggregation indicates cross-carrier scheduling, Table 1 shows candidate combinations of one or more component carriers 820 determined based on the current example. For example, according to downlinked transmission parameters known and applying the scheduling constraint, the UE 804 can determine that the potential entry sizes 41, 41, and 36 correspond to CC#1, CC#2, and CC#3, respectively.

TABLE I
Payload size of aggregated DCI vs. scheduled CCs

| | Size of aggregated DCI entries |
|---|---|
| Scheduled CCs | (CIF/SIF and CRC excluded) |
| “CC#1 only” or “CC#2 only” | 41 bits |
| CC#3 only | 36 bits |
| CC#1 and CC#2 | 82 bits |
| “CC#1 and CC#3” or “CC#2 and | 77 bits |
| CC#3” | |
| CC#1, CC#2, and CC#3 | 118 bits |

The UE 804 initially presumes that the payload size is 45. In this example, the received bits do not pass the CRC check (as described supra) under the presumption that the payload is 45 bits. Therefore, the UE 804 subsequently presumes that the payload size is 90 and performs CRC checks similarly. In this example, the received bits pass the CRC check (as described supra) under the presumption that the payload is 90 bits.

Once the correct payload size has been determined, the UE 804 can obtain the CIF 1010 from the payload. The particular carriers to which the DCI entries 814-1, 814-2, . . . 814-G are mapped can be determined based on the information in the CIF 1010. In the current example, the CIF 1010 includes three bits “101,” indicating that CC#1 and CC#3 are scheduled and that the payload includes sets of information bits 1012-1 and 1012-2 that correspond to two DCI entries 814-1 and 814-2. The UE 804 knows from the downlink transmission parameters that CC #1 and CC#3 use TM3 and TM8, respectively. The UE 804 determines, based on the known TMs and the scheduling constraint, that the possible DCI formats for the two respective DCI entries 814-1 and 814-2 are 2A and 2B. The UE 804 determines the entry size of each of the two DCI entries 814-1 and 814-2 based on its candidate DCI formats and the verified payload size of the PDCCH 812, which is 77 bits (excluding protection bits, padding bits, and CIF/SIF) as shown in the fourth entry of Table 1.

Referring back to FIGS. 9 and 11, continuing the example in which the verified payload size is 90 bits and using the first technique in which the DCI aggregation indicates cross-slot scheduling, the UE 804 determines aggregated DCI entries for multiple slots on the same component carrier on which the aggregated DCI entries are received. The UE 804 knows the transmission parameters (e.g., TMs) used for each of the slots and can, thus, determine sizes of the DCI entries directed to those slots. For example, on CC#1, the UE 804, based on transmission parameters used in slots 830-1, 830-2, 830-3, can determine that the potential DCI entry sizes are 41, 41, and 41 for slots 830-1, 830-2, 830-3, respectively.

Using the information available in the SIF 1110, the UE 804 can confirm the particular slots to which the DCI entries 814 included in the PDCCH 812 are directed. In the current example, the SIF 1110 includes three bits “101,” indicating that the payload 1100 includes sets of information bits 1012-1 and 1012-2 that are mapped to two slots 830-1 and 830-3.

Referring back to FIGS. 8, 9, 10, and 11, once the entry size of the DCI entries 814 (i.e., the number of bits in each of 1012-1 and 1012-2) is determined, the UE 804 can determine a number of padding bits 1016 that are included in the PDCCH 812 and can be ignored.

In the cross-carrier scheduling example, the aggregated sets of information bits 1012-1 and 1012-2 include 77 bits as indicated by the fourth entry in Table I, totaling 80 bits with the CIF. The remaining ten bits of the payload (90 bits) are determined to be padding bits 1016. In the cross-slot scheduling example, padding bits 1016 can be similarly determined. The UE 804 can ignore these padding bits 1016 when locating the sets of information bits 1012-1 and 1012-2 that correspond to the two DCI entries 814-1 and 814-2.

The UE 804 can now locate the sets of information bits 1012-1 and 1012-2 from the payload of the PDCCH 812 based on the verified payload size of the PDCCH 812 and the entry sizes of the two individual DCI entries 814, ignoring the padding bits 1016. In particular, the UE 804 locates sets of information bits 1012-1 as beginning at the fourth bit, after the CIF 1010, and locates the sets of information bits 1012-2 as beginning at the end of sets of information bits 1012-1, which corresponds to the first DCI entry 814-1 and is known (from downlink transmission parameters) to be 41 bits in length in both examples. The number of sets of information bits 1012-2 corresponding to the second DCI entry 814-2 is known (from downlink transmission parameters) to be 36 bits in the cross-carrier scheduling example and 41 bits in the cross-slot scheduling example. The padding bits 1216 can then be ignored.

Referring back to FIGS. 8, 9, 12, and 13 and implementation of the second technique described supra, the UE 804 receives at least one downlink communication from the base station 102 that includes a DCI aggregation indication 840 and a PDCCH 812 that includes encoded bits. The UE 804 determines from the DCI aggregation indication 840 whether the PDCCH 812 includes an aggregation of DCI entries 814. If the UE 804 determines that the DCI entries 814 are aggregated, then the UE 804 further determines from the DCI aggregation indication 840 whether the aggregated DCI entries 814 are mapped to component carriers 820 for cross-carrier scheduling or slots 830 for cross-sot scheduling. When the UE 804 determines from the DCI aggregation indication 840 that the aggregated DCI entries 814 are mapped to one or more component carriers 820, the second technique is implemented to handle cross-carrier scheduling, referring to FIGS. 8 and 12. When the UE 804 determines from the DCI aggregation indication 840 that the aggregated DCI entries 814 are mapped to one or more slots 830, the second technique is implemented to handle cross-slot scheduling, referring to FIGS. 9 and 13.

The UE 804 decodes the encoded bits of the PDCCH 812 and bits included in the payload 1000 as shown in FIG. 10 or the payload 1100 shown in FIG. 11. The payload 1000 or 1100 includes bits that correspond to a CIF 1010 or bits that correspond to an SIF 1110, sets of information bits 1012-1, 1012-2, . . . 1012-G that correspond to respective DCI entries 814-1, 814-2, . . . 814-G, individual protection bits 1202-1, 1202-2, . . . 1202-G that correspond to the respective sets of information bits 1012-1, 1012-2, . . . 1012-G, padding bits 1016, and aggregate protection bits 1014. The bits included in the payload 1000 or 1100 may be generated by the base station 102 in accordance with the techniques described supra.

In accordance with the second technique, the stored list of candidate payload size 850 is optional. If the UE 804 does store the list of candidate payload sizes 850, the payload size can be determined and verified in the same way as described for the first technique. If the UE 804 does not store the list of candidate payload sizes 850, a larger number of blind detection hypotheses can increase significantly. The aggregate CRC 1014 can be used to rule out at least a portion of candidate DCI formats. The individual protection bits 1202-1, 1202-2, . . . 1202-G associated with the association with the sets of information bits 1012-1, 1012-2, . . . 1012-G can be used to distinguish between the remaining candidates.

The UE 804 is further configured with knowledge of available component carriers 820. In an example, the UE 804 may be aware that CC#1 and CC#2 are available as component carriers 820 for downlink communications. The UE 804 is configured with knowledge whether the available component carriers 820 use FDD or TDD and knowledge of respective bandwidths and TMs of the respective available component carriers 820. In this example, CC#1 and CC#2 use FDD, the channel bandwidths for CC#1 and CC#2 are both 10 MHz, and CC#1 and CC#2 both use TM3. No particular scheduling constraint is applied.

If the UE 804 stores the candidate payload sizes 850, it tests the payload sizes listed in the candidate payload sizes 850 to determine which of the candidate payload sizes 850 stored are viable candidates as described supra.

The UE 804 can determine a payload size of the PDCCH 812 by first determining a payload size for each potential combination of component carriers 820 and format that can be scheduled and the available DCI formats than can be used, and then applying the aggregate protection bits 1014 and/or the individual protection bits 1202-1, 1202-2, . . . 1202-G to select a combination of component carriers 820 and formats used in the received PDCCH 812.

The UE 804 can then select a subset of the determined payload sizes by using aggregated protection bits 1014, e.g., by applying a CRC checking process. An example of payload sizes of potential combinations of component carriers CC#1 and CC#2 in accordance with the current example is shown in Table II, where in each entry (case IDs 1-8) represents a different potential combination of component carriers 820 that can be scheduled and the available DCI formats than can be used. Once the aggregated protection bits 1014 are applied successfully, such as a successful match between the calculated CRC and the descrambled bits, the bits of the CIF 1010 or SIF 1110 and sets of information bits 1012-1, 1012-2, . . . 1012-G can be accessed.

TABLE II
Payload size of aggregated DCI vs. scheduled CCs

| | | | | | Payload size |
|---|---|---|---|---|---|
| | | | | | of aggregated |
| | | | | | DCI |
| | CC#1 | | CC#2 | | (CIF/SIF and |
| | | DCI | | DCI | CRC |
| Case ID | Scheduled? | Format | Scheduled? | Format | excluded) |
| 1 | Yes | 1A | No | — | 26 bits |
| 2 | No | — | Yes | 1A | 26 bits |
| 3 | Yes | 2A | No | — | 41 bits |
| 4 | No | — | Yes | 2A | 41 bits |
| 5 | Yes | 1A | Yes | 1A | 52 bits |
| 6 | Yes | 1A | Yes | 2A | 67 bits |
| 7 | Yes | 2A | Yes | 1A | 67 bits |
| 8 | Yes | 2A | Yes | 2A | 82 bits |

Referring back to FIGS. 8 and 12, in an example using the second technique in which the DCI aggregation indicates cross-carrier scheduling, the CIF 1010 can be decoded and indicate which component carriers 820 are to be used, which can eliminate entries in Table II.

Referring back to FIGS. 9 and 13, in an example using the second technique in which the DCI aggregation indicates cross-slot scheduling, the UE 804 knows the component carrier via which it is receiving a downlink transmission. Entries in Table II that use other component carriers can be eliminated. Hypothetically in the current example, if cross-slot scheduling were used, entries 5-8 would be eliminated. However, the current example is described as using cross-carrier scheduling.

Table II is determined based on knowledge of the available component carriers 820 and their downlink transmission parameters. As illustrated in the current example, Table II is determined based on available component carriers CC#1 and CC#2 and their respective downlink transmission parameters. Table II shows eight cases of different scheduling combinations of component carriers CC#1 and/or CC#2 and available formats. Payload sizes of aggregated DCI entries (excluding CIF 1010 or SIF 1110 and individual protection bits 1202-1 and 1202-2 and aggregated protection bits 1014) are shown for each of the eight cases. The payload size of the aggregated DCI entries is based on the size of the sets of information bits (1012-1) and (1012-2) shown in FIG. 13.

In an example in which the DCI aggregation indicates cross-carrier scheduling, once the aggregate protection bits 1014 are applied, such as by performing a CRC checking process, to the eight different cases, cases 1-5 and 8 are excluded, with cases 6 and 7 remaining as candidate combinations of component carriers CC#1 and/or CC#2 and the available DCI formats. In this scenario, cases 6 and 7 include both CC#1 and CC#2, but using different formats, each having a payload size of 67 bits.

Having applied the aggregate protection bits 1014 successfully, the CIF 1010 and the individual protection bits 1202-1, 1202-2, . . . 1202-G can be accessed. The UE 804 can determine for each of the remaining cases the possible number of bits in each of the sets of information bits 1012-1, 1012-2, . . . 1012-G. As illustrated in the current example, for case 6, the UE 804 can deduce that one set of sets of information bits 1012-1 or 1012-2 has 26 bits and the other has 41 bits (totaling 67 bits).

Using the knowledge of the possible number of bits in each set of sets of information bits 1012-1, 1012-2, . . . 1012-G for each remaining case, the UE 804 can apply the individual protection bits 1202-1, 1202-2, . . . 1202-G to the sets of information bits 1012-1, 1012-2, . . . 1012-G of the remaining cases. Once the individual protection bits 1202-1, 1202-2, . . . 1202-G are successfully applied to one of the cases, the UE 804 can distinguish that case from the remaining cases as properly identifying the DCI entries 814.

In an example in which the DCI aggregation indicates cross-slot scheduling, hypothetical combinations (as were determined for Table II, but using only one component carrier) of the number of bits in each of the sets of information bits 1012-1, 1012-2, . . . 1012-G are determined based on the known component carrier that was used for the downlink transmission, the TMs that can be used, and the formats that can be used. Some of the hypothetical combinations are eliminated that exceed the verified payload size. The individual protection bits can be applied to select one of the hypothetical combinations. The selected hypothetical combination informs the UE 804 of the number of bits in each of the sets of information bits 1012-1, 1012-2, . . . 1012-G.

As illustrated in the current example, the UE 804 can apply the individual protection bits 1202-1 and 1202-2 to the sets of information bits 1012-1 and 1012-2 in cases 6 and 7. In case 6, sets of information bits 1012-1 and 1012-2 have 26 and 41 bits, respectively. In case 7, sets of information bits 1012-1 and 1012-2 have 41 and 26 bits, respectively. In this example, the individual protection bits 1201-1 and 1202-2 are successfully applied in case 6.

Once the number of bits in each of the sets of information bits 1012-1, 1012-2, . . . 1012-G is determined, and the size of the CIF 1010 or SIF 1110 and the size of the individual protection bits 1202-1, 1202-2, . . . 1202-G is known, the UE 804 can locate the sets of information bits 1012-1 and 1012-2 from the payload of the PDCCH 812. As illustrated in the current example, the CIF 1010 or SIF 1110 is known to have three bits. The UE 804 locates sets of information bits 1012-1 as beginning at the fourth bit, after the CIF 1010 or SIF 1110. The UE 804 can use its knowledge of the number bits (e.g., 26 bits) to access the sets of information bits 1012-1. The UE 804 can skip the individual protection bits 1202-1 (using its knowledge of the number of bits in the individual protection bits 1202-1) and access the adjacent sets of information bits 1012-2 using its knowledge of the number of bits (e.g., 41 bits).

When the UE 804 stores the set of candidate payload sizes 850, the UE 804 has the ability to use this knowledge to determine a verified payload size as described infra with respect to the first technique, and thus potentially eliminate some entries from Table II. The UE 804 can determine that a known sequence of X bits (X≥0), such as padding bits 1016, are appended after the last set of individual protection bits 1202-G to yield the verified payload size and ignore these bits.

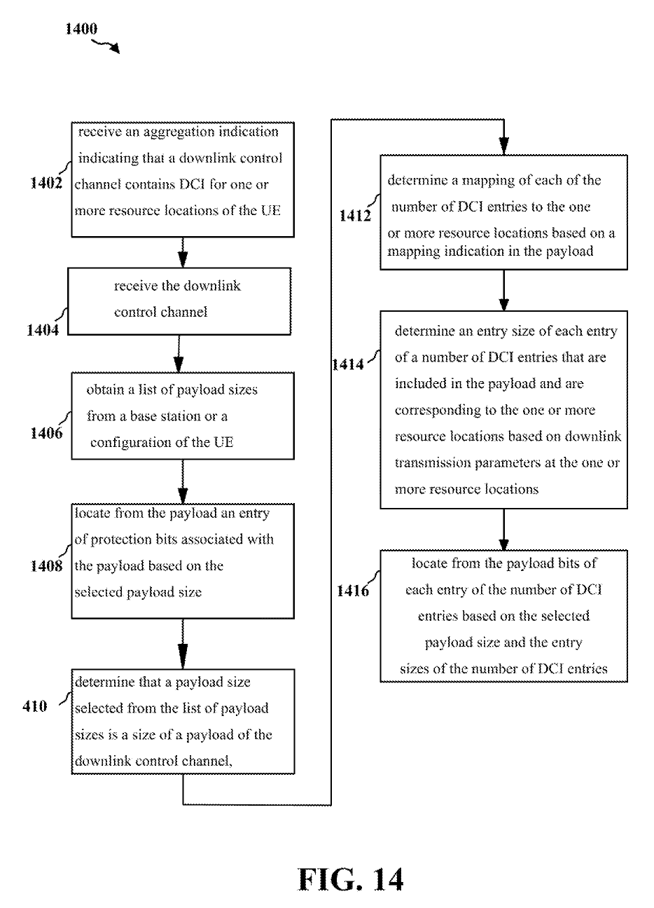

FIG. 14 is a flowchart 1400 of a method (process) in accordance with the first technique for processing a downlink control channel, such as PDCCH 812 shown in FIGS. 8 and 9. The method is performed by a UE 804, apparatus 1602, and apparatus 1602′. At operation 1402, the UE receives an aggregation indication indicating that a downlink control channel contains DCI for one or more resource locations of the UE. The one or more resource locations are one or more component carriers scheduled for downlink communication or one or more time slots on a particular component carrier. At operation 1404, the UE receives the downlink control channel. At operation 1406, the UE obtains a list of payload sizes from a base station or a configuration of the UE. At operation 1408, the UE locates from the payload an entry of protection bits associated with the payload based on the selected payload size. At operation 1410, the UE determines that a payload size selected from the list of payload sizes is a size of a payload of the downlink control channel, wherein the selected payload size is determined to be the size of the payload based on the entry of protection bits.

At operation 1412, the UE determines a mapping of each of the number of DCI entries to the one or more resource locations based on a mapping indication in the payload. The mapping indication can be a CIF or SIF, such as CIF 1010 shown in FIG. 10 or SIF 1110 shown in FIG. 11. At operation 1414, the UE determines an entry size of each entry of a number of DCI entries that are included in the payload and are corresponding to the one or more resource locations based on downlink transmission parameters at the one or more resource locations, wherein the entry size of each entry of the number of DCI entries is determined further based on the mapping and a scheduling constraint (i.e., that restricts a number of possible formats of each of the DCI entries to one format or one set of formats). The downlink transmission parameters can include transmission modes at the one or more resource locations. The scheduling constraint can include a restriction whether the transmission modes are non-fallback modes or fallback modes.

At operation 1416, the UE locates from the payload, based on the selected payload size and the entry sizes of the number of DCI entries, bits of each entry of the number of DCI entries. Locating the number of DCI entries can include determining padding bits included in the payload based on the selected payload size and entry sizes of the number of DCI entries. The padding bits can be ignored.

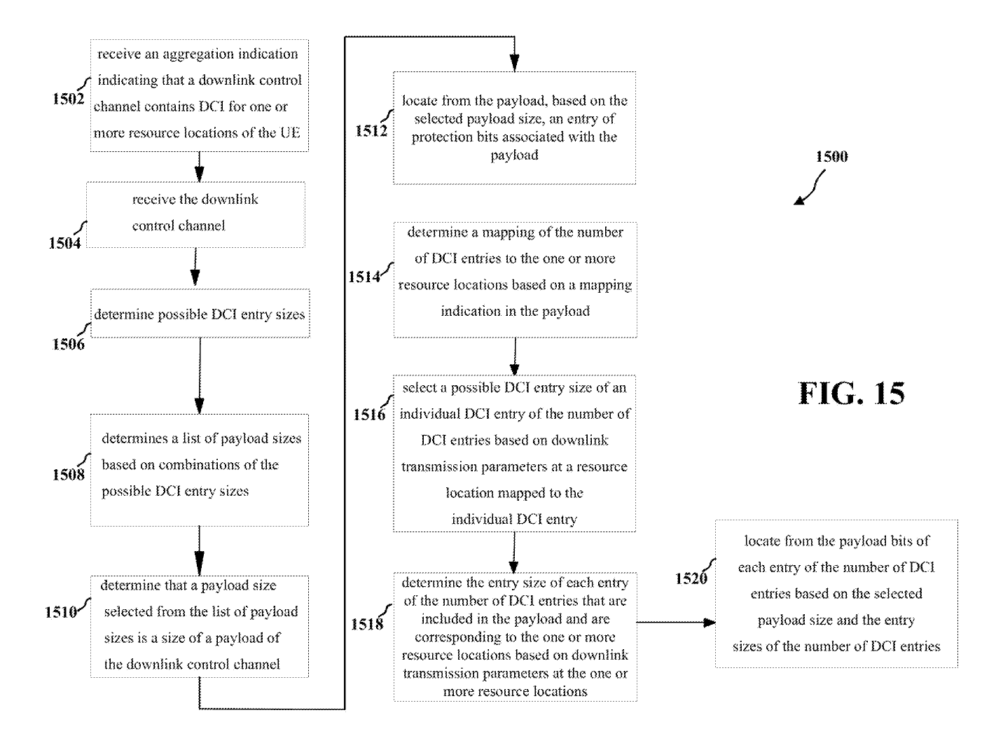

FIG. 15 is a flowchart 1500 of a method (process) in accordance with the second technique for processing a downlink control channel, such as PDCCH 812 shown in FIGS. 8 and 9. The method is performed by a UE 804, apparatus 1602, and apparatus 1602′. At operation 1502, the UE receives an aggregation indication indicating that a downlink control channel contains DCI for one or more resource locations of the UE. The one or more resource locations are one or more component carriers scheduled for downlink communication or one or more time slots on a particular component carrier. At operation 1504, the UE receives the downlink control channel.

At operation 1506, the UE determines possible DCI entry sizes for DCI entries corresponding to resource locations employed by the UE based on downlink transmission parameters at the employed resource locations, wherein the employed resource locations include the one or more resource locations. At operation 1508, the UE determines a list of payload sizes based on combinations of the possible DCI entry sizes. At operation 1510, the UE determines that a payload size selected from the list of payload sizes is a size of a payload of the downlink control channel.

At operation 1512, the UE locates from the payload, based on the selected payload size, an entry of protection bits associated with the payload, wherein the selected payload size is determined based on the entry of protection bits. At operation 1514, the UE determines a mapping of the number of DCI entries to the one or more resource locations based on a mapping indication in the payload. The mapping indication can be a CIF or SIF, such as CIF 1010 shown in FIG. 12 or SIF 1110 shown in FIG. 13.

At operation 1516, the UE selects a possible DCI entry size of an individual DCI entry of the number of DCI entries based on downlink transmission parameters at a resource location mapped to the individual DCI entry. At operation 1518, the UE determines the entry size of each entry of the number of DCI entries that are included in the payload and are corresponding to the one or more resource locations based on downlink transmission parameters at the one or more resource locations by determining, for each entry of the number of DCI entries, whether the selected possible DCI entry size is an entry size of the individual DCI entry based on an entry of protection bits associated with the individual DCI entry.

At operation 1520, the UE locates from the payload, based on the selected payload size and the entry sizes of the number of DCI entries, bits of each entry of the number of DCI entries.

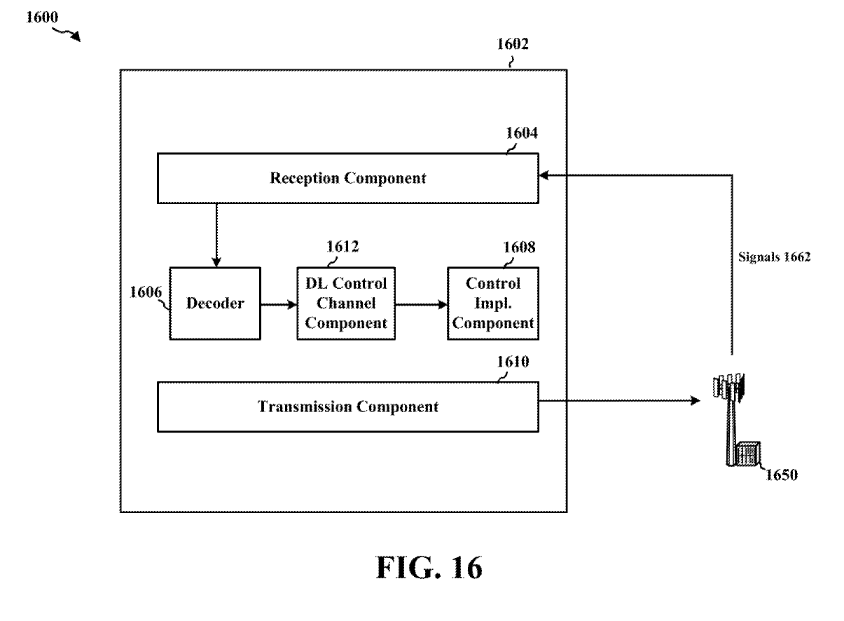

FIG. 16 is a conceptual data flow diagram 1600 illustrating the data flow between different components/means in an exemplary apparatus 1602. The apparatus 1602 may be a UE. The apparatus 1602 includes a reception component 1604, a decoder 1606, a downlink control channel component 1612, a control implementation component 1608, and a transmission component 1610. The reception component 1604 may receive transmission signals 1662 including a downlink control channel from a base station 1650.

In one aspect, the decoder 1606 decodes the signals 1662 to access an aggregation indication. The downlink control channel component 1612 determines whether the aggregation indication indicates that a downlink control channel contains downlink control information (DCI) for one or more resource locations of the UE. The one or more resource locations can be (a) one or more component carriers scheduled for downlink communication or (b) one or more time slots on a particular component carrier.

The downlink control channel component 1612 determines that a payload size selected from a list of payload sizes is a size of a payload of the downlink control channel. The downlink (DL) control channel component 1612 determines an entry size of each entry of a number of DCI entries that are included in the payload and correspond to the one or more resource locations based on downlink transmission parameters at the one or more resource locations. The downlink control channel component 1612 locates bits of each entry of the number of DCI entries from the payload based on the selected payload size and the entry sizes of the number of DCI entries. The downlink control channel component 1612 sends downlink control information included in the bits of the DCI entries to the control implementation component 1608, which subsequently operates the UE in accordance with the downlink control information.

In one aspect, the decoder 1606 decodes the signals 1662 to access an aggregation indication. The downlink control channel component 1612 determines whether the aggregation indication indicates that a downlink control channel contains downlink control information (DCI) for one or more resource locations of the UE. The one or more resource locations can be (a) one or more component carriers scheduled for downlink communication or (b) one or more time slots on a particular component carrier.

The downlink control channel component 1612 obtains a list of payload sizes from a base station or a configuration of the UE. The downlink control channel component 1612 locates from the payload an entry of protection bits associated with the payload based on the selected payload size. The downlink control channel component 1612 determines that a payload size selected from the list of payload sizes is a size of a payload of the downlink control channel, wherein the selected payload size is determined to be the size of the payload based on the entry of protection bits.

The downlink control channel component 1612 determines a mapping of each of the number of DCI entries to the one or more resource locations based on a mapping indication in the payload. The mapping indication can be a CIF or SIF, such as CIF 1010 shown in FIG. 10 or SIF 1110 shown in FIG. 11.

The downlink control channel component 1612 determines an entry size of each entry of a number of DCI entries that are included in the payload and correspond to the one or more resource locations based on downlink transmission parameters at the one or more resource locations. In particular, the downlink control channel component 1612 determines the entry size of each entry of the number of DCI entries based on the mapping and a scheduling constraint that restricts a number of possible formats of each of the DCI entries to one format or one set of formats. In particular, the downlink transmission parameters can include transmission modes at the one or more resource locations. The scheduling constraint can include a restriction whether the transmission modes are non-fallback modes or fallback modes.

The downlink control channel component 1612 locates from the payload, based on the selected payload size and the entry sizes of the number of DCI entries, bits of each entry of the number of DCI entries. The downlink control channel component 1612 can ignore the padding bits. The downlink control channel component 1612 sends downlink control information included in the bits of the DCI entries to the control implementation component 1608, which subsequently operates the UE in accordance with the downlink control information.

In another aspect, the decoder 1606 decodes the signals 1662 to access an aggregation indication. The downlink control channel component 1612 determines whether the aggregation indication indicates that a downlink control channel contains downlink control information (DCI) for one or more resource locations of the UE. The one or more resource locations can be (a) one or more component carriers scheduled for downlink communication or (b) one or more time slots on a particular component carrier.

The downlink control channel component 1612 determines possible DCI entry sizes for DCI entries corresponding to resource locations employed by the UE based on downlink transmission parameters at the employed resource locations, wherein the employed resource locations include the one or more resource locations. The downlink control channel component 1612 determines a list of payload sizes based on combinations of the possible DCI entry sizes. The downlink control channel component 1612 determines that a payload size selected from the list of payload sizes is a size of a payload of the downlink control channel.

The downlink control channel component 1612 locates from the payload, based on the selected payload size, an entry of protection bits associated with the payload, wherein the selected payload size is determined to be the size of the payload based on the entry of protection bits. The downlink control channel component 1612 determines a mapping of the number of DCI entries to the one or more resource locations based on a mapping indication in the payload. The mapping indication can be a CIF or SIF, such as CIF 1010 shown in FIG. 12 or SIF 1110 shown in FIG. 13.

The downlink control channel component 1612 selects a possible DCI entry size of an individual DCI entry of the number of DCI entries based on downlink transmission parameters at a resource location mapped to the individual DCI entry. The downlink control channel component 1612 determines the entry size of each entry of the number of DCI entries that are included in the payload and correspond to the one or more resource locations based on downlink transmission parameters at the one or more resource locations by determining, for each entry of the number of DCI entries, whether the selected possible DCI entry size is an entry size of the individual DCI entry based on an entry of protection bits associated with the individual DCI entry.

The downlink control channel component 1612 locates bits of each entry of the number of DCI entries from the payload, based on the selected payload size and the entry sizes of the number of DCI entries. The downlink control channel component 1612 sends downlink control information included in the bits of the DCI entries to the control implementation component 1608, which subsequently operates the UE in accordance with the downlink control information.

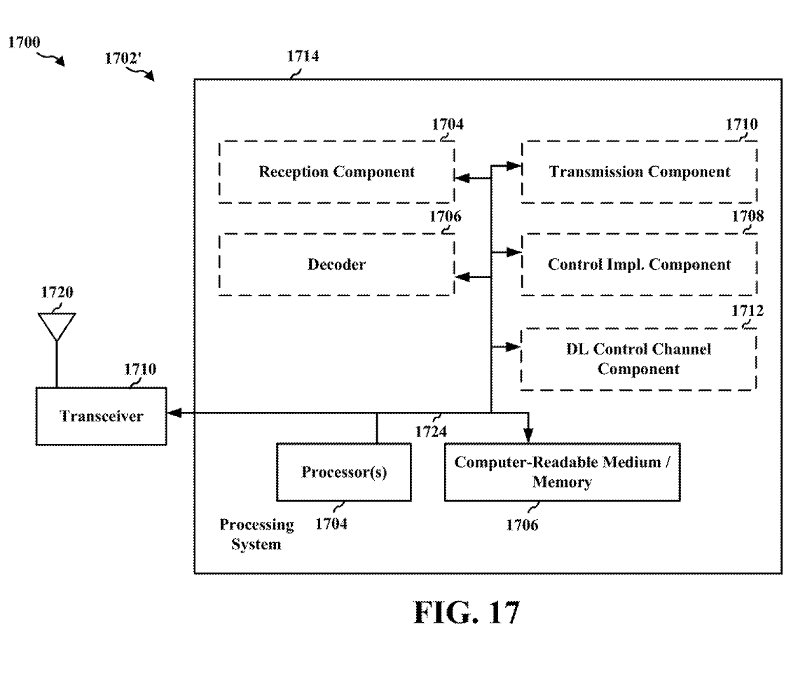

FIG. 17 is a diagram 1700 illustrating an example of a hardware implementation for an apparatus 1602′ employing a processing system 1714. The processing system 1714 may be implemented with a bus architecture, represented generally by a bus 1724. The bus 1724 may include any number of interconnecting buses and bridges depending on the specific application of the processing system 1714 and the overall design constraints. The bus 1724 links together various circuits including one or more processors and/or hardware components, represented by one or more processors 1704, the reception component 1604, the decoder 1606, the downlink control channel component 1612, the control implementation component 1608, the transmission component 1610, and a computer-readable medium/memory 1706. The bus 1724 may also link various other circuits such as timing sources, peripherals, voltage regulators, and power management circuits, etc.

The processing system 1714 may be coupled to a transceiver 1710, which may be one or more of the transceivers 354. The transceiver 1710 is coupled to one or more antennas 1720, which may be the communication antennas 352.

The transceiver 1710 provides a means for communicating with various other apparatus over a transmission medium. The transceiver 1710 receives a signal from the one or more antennas 1720, extracts information from the received signal, and provides the extracted information to the processing system 1714, specifically the reception component 1604. In addition, the transceiver 1710 receives information from the processing system 1714, specifically the transmission component 1610, and based on the received information, generates a signal to be applied to the one or more antennas 1720.

The processing system 1714 includes one or more processors 1704 coupled to a computer-readable medium/memory 1706. The one or more processors 1704 are responsible for general processing, including the execution of software stored on the computer-readable medium/memory 1706. The software, when executed by the one or more processors 1704, causes the processing system 1714 to perform the various functions described supra for any particular apparatus. The computer-readable medium/memory 1706 may also be used for storing data that is manipulated by the one or more processors 1704 when executing software. The processing system 1714 further includes at least one of the reception component 1604, the decoder 1606, the downlink control channel component 1612, the control implementation component 1608, and the transmission component 1610. The components may be software components running in the one or more processors 1704, resident/stored in the computer readable medium/memory 1706, one or more hardware components coupled to the one or more processors 1704, or some combination thereof. The processing system 1714 may be a component of the UE 804 and may include the memory 360 and/or at least one of the TX processor 368, the RX processor 356, and the controller/processor 359.

In one configuration, the apparatus 1602/apparatus 1602′ for wireless communication includes means for performing each of the operations of FIGS. 13 and 14. The aforementioned means may be one or more of the aforementioned components of the apparatus 1602 and/or the processing system 1714 of the apparatus 1602′ configured to perform the functions recited by the aforementioned means. As described supra, the processing system 1714 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
receiving an aggregation indication indicating that a downlink control channel contains downlink control information (DCI) for one or more resource locations of the UE, the one or more resource locations being (a) one or more component carriers scheduled for downlink communication or (b) one or more time slots on a particular component carrier;
receiving the downlink control channel;
determining that a payload size selected from a list of payload sizes is a size of a payload of the downlink control channel;
determining an entry size of each entry of a number of DCI entries that are included in the payload and are corresponding to the one or more resource locations based on downlink transmission parameters at the one or more resource locations; and
locating from the payload, based on the selected payload size and the entry sizes of the number of DCI entries, bits of each entry of the number of DCI entries.

2. The method of claim 1, further comprising:
obtaining the list of payload sizes from a base station or a configuration of the UE.

3. The method of claim 1, further comprising:
determining a mapping of each of the number of DCI entries to the one or more resource locations based on a mapping indication in the payload, wherein the entry size of each entry of the number of DCI entries is determined further based on the mapping and a scheduling constraint that restricts a number of possible formats of each of the DCI entries to one format or one set of formats.

4. The method of claim 3, wherein the downlink transmission parameters include transmission modes at the one or more resource locations, wherein the scheduling constraint includes a restriction whether the transmission modes are non-fallback modes or fallback modes.

5. The method of claim 1, further comprising:
determining possible DCI entry sizes for DCI entries corresponding to resource locations employed by the UE based on downlink transmission parameters at the employed resource locations, the employed resource locations including the one or more resource locations; and
determining the list of payload sizes based on combinations of the possible DCI entry sizes.

6. The method of claim 5, further comprising:
determining a mapping of the number of DCI entries to the one or more resource locations based on a mapping indication in the payload, wherein determining the entry size of each entry of the number of DCI entries includes:
selecting a possible DCI entry size of an individual DCI entry of the number of DCI entries based on downlink transmission parameters at a resource location mapped to the individual DCI entry; and
determining whether the selected possible DCI entry size is an entry size of the individual DCI entry based on an entry of protection bits associated with the individual DCI entry.

7. The method of claim 1, further comprising: locating from the payload an entry of protection bits associated with the payload based on the selected payload size, wherein the selected payload size is determined to be the size of the payload based on the entry of protection bits.

8. The method of claim 1, further comprising:
determining padding bits included in the payload based on the selected payload size and entry sizes of the number of DCI entries.

9. A user equipment (UE) of a wireless communication system, comprising:
a memory; and
at least one processor coupled to the memory and configured to:
receive an aggregation indication indicating that a downlink control channel contains downlink control information (DCI) for one or more resource locations of the UE, the one or more resource locations being (a) one or more component carriers scheduled for downlink communication or (b) one or more time slots on a particular component carrier;
receive the downlink control channel;
determine that a payload size selected from a list of payload sizes is a size of a payload of the downlink control channel;
determine an entry size of each entry of a number of DCI entries that are included in the payload and are corresponding to the one or more resource locations based on downlink transmission parameters at the one or more resource locations; and
locate from the payload, based on the selected payload size and the entry sizes of the number of DCI entries, bits of each entry of the number of DCI entries.

10. The UE of claim 9, wherein the at least one processor is further configured to:
obtain the list of payload sizes from a base station or a configuration of the UE.

11. The UE of claim 9, wherein the at least one processor is further configured to:
determine a mapping of each of the number of DCI entries to the one or more resource locations based on a mapping indication in the payload, wherein the entry size of each entry of the number of DCI entries is determined further based on the mapping and a scheduling constraint that restricts a number of possible formats of each of the DCI entries to one format or one set of formats.

12. The UE of claim 11, wherein the downlink transmission parameters include transmission modes at the one or more resource locations, wherein the scheduling constraint includes a restriction whether the transmission modes are non-fallback modes or fallback modes.

13. The UE of claim 9, wherein the at least one processor is further configured to:
determine possible DCI entry sizes for DCI entries corresponding to resource locations employed by the UE based on downlink transmission parameters at the employed resource locations, the employed resource locations including the one or more resource locations; and
determine the list of payload sizes based on combinations of the possible DCI entry sizes.

14. The UE of claim 13, wherein the at least one processor is further configured to:
determine a mapping of the number of DCI entries to the one or more resource locations based on a mapping indication in the payload, wherein determining the entry size of each entry of the number of DCI entries includes:
select a possible DCI entry size of an individual DCI entry of the number of DCI entries based on downlink transmission parameters at a resource location mapped to the individual DCI entry; and
determine whether the selected possible DCI entry size is an entry size of the individual DCI entry based on an entry of protection bits associated with the individual DCI entry.

15. The UE of claim 9, wherein the at least one processor is further configured to:
locate from the payload an entry of protection bits associated with the payload based on the selected payload size, wherein the selected payload size is determined to be the size of the payload based on the entry of protection bits.

16. The UE of claim 9, wherein the at least one processor is further configured to:
determine padding bits included in the payload based on the selected payload size and entry sizes of the number of DCI entries.

17. A computer-readable medium storing computer executable code for a wireless communication system including a user equipment (UE), comprising code to:
receive an aggregation indication indicating that a downlink control channel contains downlink control information (DCI) for one or more resource locations of the UE, the one or more resource locations being (a) one or more component carriers in a particular time slot or (b) one or more time slots on a particular component carrier;
receive the downlink control channel;
determine that a payload size selected from a list of payload sizes is a size of a payload of the downlink control channel;
determine an entry size of each entry of a number of DCI entries that are included in the payload and are corresponding to the one or more resource locations based on downlink transmission parameters at the one or more resource locations; and
locate from the payload, based on the selected payload size and the entry sizes of the number of DCI entries, bits of each entry of the number of DCI entries.

18. The computer-readable medium of claim 17, further comprising code to:
determine a mapping of each of the number of DCI entries to the one or more resource locations based on a mapping indication in the payload, wherein the entry size of each entry of the number of DCI entries is determined further based on the mapping and a scheduling constraint that restricts a number of possible formats of each of the DCI entries to one format or one set of formats.

19. The computer-readable medium of claim 17, further comprising code to:
determine possible DCI entry sizes for DCI entries corresponding to resource locations employed by the UE based on downlink transmission parameters at the employed resource locations, the employed resource locations including the one or more resource locations; and
determine the list of payload sizes based on combinations of the possible DCI entry sizes.

20. The computer-readable medium of claim 19, comprising code to:
determine a mapping of the number of DCI entries to the one or more resource locations based on a mapping indication in the payload, wherein determining the entry size of each entry of the number of DCI entries includes:
select a possible DCI entry size of an individual DCI entry of the number of DCI entries based on downlink transmission parameters at a resource location mapped to the individual DCI entry; and
determine whether the selected possible DCI entry size is an entry size of the individual DCI entry based on an entry of protection bits associated with the individual DCI entry.
